(19) United States
(12) Patent Application Publication
(10) Pub. No.: US 2005/0228654 A1
(43) Pub. Date: Oct. 13, 2005

(54) Method and apparatus for improved bit rate efficiency in wavelet based codecs by means of subband correlation

(76) Inventors: Yolanda Prieto, Miami, FL (US); Jose I. Suarez, (US); Yolanda Prieto, (US)

Correspondence Address: MOTOROLA, INC., 1303 EAST ALGONQUIN ROAD, IL01/3RD, SCHAUMBURG, IL, 60196, US

(21) Appl. No.: 10/813,472

(22) Filed: Mar. 30, 2004

(51) Int. Cl. G10L 19/10

(52) U.S. Cl. 704/220

(57) ABSTRACT

An encoder (1600) and decoder (1700) for improving bit rate efficiency in a wavelet based codec includes an analysis filter bank (1601) for decorrelating the input data signal. A set of decimators (1701) are used to down sample the filtered input data signal and a predictor (1705) is used to extract cross subband dependence. The predictors (804, 904, 1104, 1204, 1304) are used in order to reduce the number of bytes of an encoded input data signal X(Z). The predictors exploit existing correlation amongst the subbands resulting from a multi-level analysis wavelet transformation or filter bank processing. Decimation required by the analysis filter bank is placed around the predictor on the basis of spatial location variance minimization to further facilitate subband prediction, and on computational complexity of the overall system.

### CROSS REFERENCE TO RELATED APPLICATIONS

This application is related to U.S. Pat. No. 6,278,753 by Jose Suarez et al., entitled “Method and Apparatus for Creating and Implementing Wavelet Filters in a Digital System,” U.S. Pat. No. 6,128,346 by Suarez et al., entitled “Method and Apparatus for Quantizing a Signal in a Digital System”, and U.S. Pat. No. 6,661,927 by Suarez et al., entitled “System and Method for Efficiently Encoding an Image by Prioritizing Groups of Spatially Correlated Coefficients Based on an Activity Measure” previously filed and all assigned to Motorola, Inc.

### TECHNICAL FIELD

This invention pertains in general to encoding data to reduce its required byte count by reducing the amount of bits required per pixel and more particularly to a bandwidth limited system for improved bit rate efficiency that utilizes spatially correlated subbands in a subband coding system.

### BACKGROUND

With the advent of technologies and services related to teleconferencing and digital image storage, considerable progress has been made in the field of digital signal processing. As will be appreciated by those skilled in the art, one example of digital signal processing relates to systems, devices, and methodologies for generating a sampled data signal, compressing the signal for storage and/or transmission, and thereafter reconstructing the original data from the compressed signal. Critical to any highly efficient, cost effective, and bandwidth limited digital signal processing system is the methodology used for achieving compression and bit rate efficiency.

As is known in the art, data compression refers to the steps performed to map an original data signal into a bit stream suitable for communication over a channel or storage in a suitable medium. Methodologies capable of minimizing the amount of information necessary to represent and recover an original data are desirable in order to lower computational complexity, system bandwidth, and cost. In addition to these factors, simplicity of hardware and software implementations capable of providing high quality data reproduction with minimal bits per pixel (bpp) is likewise desirable.

Various prior art schemes exist for encoding data. A key objective of encoding data is to ‘compress’ the data, i.e., to reduce the byte size of the data. This is desirable in order to reduce memory space required to store the data, and reduce the time required to transmit data through a communication channel having a certain finite bandwidth. The byte size is typically expressed as bits per sample, or as is conventional in the case of image data, as bits per pixel (bpp). The two classes of encoding methods typically include both lossless encoding and lossy encoding. The former, more conservative approach endeavors to preserve every detail of the input data in the encoded form. Ideally, the decoded version would be an indistinguishable replica of the input data. In the case of lossy data encoding, the level to which the detail of the image is preserved can be selected where there is a tradeoff between the level of detail preserved and the byte size of the resulting encoded data.

Often when using lossy data encoding, the goal is to obtain a level of detail preservation such that the differences between a decoded version and the original image are imperceptible. Judgments about the design and configuration of the lossy encoder to achieve imperceptible differences will be made in consideration of human perception models (e.g., hearing, or visual). A good lossy encoder and corresponding decoder will yield a decoded data set which may be distinguished from the original data set by rigorous scientific analysis but is indistinguishable to a human observer when presented in an intended format.

One step in the process of data encoding methods applicable to image data is referred to as transform coding. Generally, transform coding utilizes an ordered data set that is projected onto an orthogonal set of basis functions to obtain a set of transformed data coefficients inner products. The traditional type of transform coding derives from Fourier analysis. In Fourier based techniques, a data set is projected onto a function set derived from sinusoidal functions. The outdated JPEG standard (ISO/IEC 10928-1) is an example of a transform encoding method based on Fourier analysis. This older JPEG standard specifies a set of transform matrices which are discrete representations of products of a cosine function with a horizontal coordinate dependent argument and a cosine function with a vertical coordinate dependent argument. These basis functions are applied to analyze 8 by 8 pixel blocks of an input image.

A shortcoming of these Fourier based techniques, which prompted the industry to take up other methods, is the fact that the sinusoidal function repeat indefinitely out to plus and minus infinity, whereas data sets which are encoded are localized in the time (or spatial) domain and have features which are further localized within the data set. Given the unbounded domain of Fourier bases functions and the periodic nature of data sets to be encoded over long intervals or spans one is led to segment the signal (e.g., into the aforementioned 8 by 8 blocks) in order to obtain a more efficient encoding.

Unfortunately, this leads to abrupt jumps in the decoded version of the signal at edges between the segments. Those skilled in the image processing art will recognize this as a “blocking effect.” With regard to lossy encoding, whether it be Fourier, wavelet or otherwise based, the manner in which the reduction in the byte size with the associated loss of detail is achieved, according to the common prior art approach, is by quantizing and or coding the transformed data coefficients. Quantizing and or coding involve adjusting downward the resolution with which the value of the transformed data coefficients are recorded, so that they can be recorded using fewer bits.

In the case of image data, transformed data coefficients associated with basis function that depend on finer details, i.e., higher frequency subbands, in the data may be quantized or coded with less resolution or fewer bits. Alternatively, these higher frequency subbands will be predicted from their spatially correlated lower frequency subbands. In narrow band systems and others in which there is a need in reducing the amount of information to be transmitted, it becomes important to reduce the number of data bits to be coded even prior to the quantization step. Because systems that implement discrete wavelet transforms involve decimation of the samples, spatial location variance is introduced.

Newer classes of transform methods employ basis functions which are inherently localized in the spatial domain. Mathematically these are compactly supported. One example of the newer type of transform method is the wavelet based technique. Wavelet based techniques employ a set of basis functions comprising a mother wavelet and a set of child wavelets derived from the mother wavelet by applying different time or spatial domain shifts and dilations to the mother wavelet. A wavelet basis set comprising a set of functions with localized features at different characteristic scales, is better suited to encode data sets such as image or audio data sets which have fine, coarse and intermediate features at different locations (times). At present, there are various systems employing wavelets as means of decomposing the signal with the purpose of decorrelating the input image data. One such example is the Joint Photographic Experts Group system (JPEG 2000 standard) for still images proposes algorithms which use multilevel wavelets to achieve decomposition of an input signal. As will be recognized by those skilled in the art, multilevel wavelet decomposition is an iterative process, namely multi-resolutional decomposition. At each iteration a lower frequency set of transformed data coefficients generated by a prior iteration is again refined to produce a substitute set of transformed data coefficients including a lower spatial frequency group and a higher spatial frequency group, called subbands.

In other signal processing literature, several authors have also explored the relationship between wavelets and multirate filter banks. For example in tutorials by Rioul and Vetterli [1991], Vetterli and Herley [1992], Akansu and Liu [1991], in the books Multiresolutional Signal Decomposition, Transforms, Subbands, and Wavelets by Ali N. Akansu and Richard A. Haddad, Academic Press, [1992], Wavelets and Filter Banks authored by Gilbert Strang and Truong Nguyen, Wellesley-Cambridge Press, [1996]. Tree structured filter banks are used in various applications, both in one-dimensional and two-dimensional processing.

Prior art FIG. 1 illustrates a four-channel, three level system with equal decimation ratios, where H₀(z) and H₁(z) in the analysis bank represent a high-pass pair, respectively. One attractive property of wavelets is their ability to adjust the lengths of basis functions. The three level wavelet decomposition shown in FIG. 1 contains a lowest frequency basis function, denoted by a resulting filter H₄(z) in Equation 1, which is a cascade of interpolated versions of the filter H₀(z). Its effective length is large.
H₄(z)=H₀(z)H₀(z²)H₀(z⁴) eq. (1)

FIG. 2 shows the equivalent four-channel system of FIG. 1, where H₄(z) is given by equation (1). Similarly

$$\begin{matrix}{H}_{3} ( z ) = {H}_{0} ( z ) {H}_{0} ( {z}^{2} ) {H}_{1} ( {z}^{4} ) and & eq . ( 2 ) \\ {H}_{2} ( z ) = {H}_{0} ( z ) {H}_{1} ( {z}^{2} ) and & eq . ( 3 ) \\ {{H}_{1} ( z )}_{( FIG . 2 )} = {{H}_{1} ( z )}_{( FIG . 1 )} & eq . ( 4 )\end{matrix}$$

The corresponding synthesis filter bank is shown in FIG. 3, where G₀(z) and G₁(z) represent the low-pass and high-pass synthesis filters, respectively. The design of the analysis and synthesis filters depends on the application. Of special interest are systems requiring perfect reconstruction (PR) of the input signal; that is, systems where the output signal, \tilde{X}(z) and input signal X(z) may only differ by a delay. The relationship between the analysis low-pass and high-pass filters and the synthesis filters (low-pass and high-pass) in PR systems can be found in the book Multirate Systems and Filter Banks by P. P. Vaidyanathan, Prentice Hall Signal Processing Series.

FIG. 4 shows the equivalent system to the four-channel synthesis filter bank of FIG. 3. Subbands Y₀(z), Y₁(z), Y₂(z), and Y₃(z) in both FIGS. 3 and 4 are the inputs to the synthesis filter bank which correspond accordingly to the outputs of the analysis filter bank shown in FIGS. 1 and 2. This feed-through type of connection assumes a system where only wavelet filter bank processing takes place; such a system assumes no quantization and no coding. However, the invention here detailed is not limited to systems where only wavelet filter processing is performed, rather it also applies to lossy systems where quantization and coding take place between the analysis and synthesis filter banks.

Subband coding using wavelets, i.e. tree structured filter banks have basis functions of variable lengths. Long basis functions represent the low frequency such as the flat background in images, whereas short basis functions represent higher frequencies such as the regions with texture. In the case of one-dimensional processing, referring to FIGS. 1-4, subband Y₀(z) represents the higher frequency subband, while Y₃(z) represents the lowest frequency subband resulting from the 3^{rd} level processing. Similarly in the case of processing a two-dimensional input signal such as an image, Y₀(z) would represent the three high frequency subbands obtained after processing the wavelet filter bank in two dimensions.

FIG. 5 illustrates tree structured filter banks of the prior art that give rise to non-uniform filter bandwidths and shows typical and ideal magnitude responses of the filters in the analysis and synthesis filter banks shown in previous figures. Higher frequencies are iterated less, thus the basis functions become shorter. After three or more levels, most of the signal energy is in the lowest pass subband that is the LLLLLL subband for a three level wavelet decomposition as best seen in FIG. 7. It is well known in the art that there is a relationship between the wavelet transform and multirate filter banks. P. P. Vaidyanathan in Chapter 11 of Multirate Systems and Filter Banks, Prentice Hall, presents this theoretical analysis. Here, Vaidyanathan also mentions that Daubechies developed a systematic technique for generating finite-duration orthonormal wavelets establishing the connection between continuous time orthonormal wavelets and the digital filter bank. Moreover, this publication further illustrates that wavelet transforms are closely related to the structured digital filter bank, and hence to the multi-resolutional analysis.

In FIG. 6, the subbands in a one-level, two-channel discrete wavelet decomposition are shown after the analysis bank is processed two-dimensionally. The upper left sub-image is obtained by low-pass filtering in both the horizontal and vertical directions (2-dimensional), indicated by the LL subband. The other three images, HH, HL, and LH subbands have details involving higher frequencies.

Finally FIG. 7 shows a three-level discrete wavelet decomposition after applying the analysis filter bank of FIG. 1 as a separable transform in both the horizontal and vertical directions. In the book Wavelets and Filter Banks, Strang and Nguyen show that subbands 2, 5, and 8 are highly correlated since 2 is the coarse approximation of 5, and 5 is the coarse approximation of 8. For example, if the input image were applied to the three-level analysis filter bank of FIG. 1, the transformed pixel value that is spatially located in the upper left corner of subband 2 is zero, then it is very likely that the spatially correlated pixels corresponding in the 2×2 area of the upper left corner of subband 5 are also zero. Similarly, the pixels in the 4×4 area of subband 8, which are spatially correlated to those in subbands 2, and 5 are most likely zero.

Thus, the need exists to provide a method to exploit cross-band correlation in wavelet based codecs even in the presence of a spatial variance introduced by the decimator in order to improve bit rate efficiency.

### SUMMARY OF THE INVENTION

This invention proposes various solutions to improve bit rate efficiency of signals in encoding and decoding systems involving subband coding. The process of applying a wavelet transform signal decomposition typically involves the steps of filtering and decimation to yield subbands that have spatial correlation amongst them. However, due to the spatial location variance introduced by decimation, the spatial correlation amongst the subbands becomes less obvious and more difficult to exploit. The present invention uses various systems to overcome this difficulty while using subband correlation to minimize the amount of data that needs to be transmitted. Predictors are used to extract cross-subband dependence allowing the large amount of data in the higher frequency subbands to be derived from corresponding lower resolutional bandwidth subbands, thus reducing the amount of processing and coding.

### BRIEF DESCRIPTION OF THE FIGURES

FIG. 1 illustrates a prior art four-channel, three-level analysis filter bank, where H₀(z) and H₁(z) are low-pass and high-pass filters, respectively.

FIG. 2 depicts a prior art four-channel system equivalent to three-level analysis filter bank shown in FIG. 1.

FIG. 3 illustrates a prior art four-channel, three-level synthesis filter bank corresponding to the analysis filter bank shown in FIG. 1.

FIG. 4 illustrates a prior art four-channel system equivalent to the three-level synthesis filter bank shown in FIG. 3.

FIG. 5 depicts a prior art typical and ideal magnitude response of the filters shown in FIGS. 2 and 4.

FIG. 6 illustrates a prior art one-level discrete wavelet transform applied in the horizontal and vertical directions.

FIG. 7 illustrates a prior art three-level discrete wavelet transform applied in the horizontal and vertical directions where arrows indicate subband correlation, shaded area in subbands show effect of decimation in the three levels of decomposition.

FIG. 8 illustrates an encoding system consisting of an analysis filter bank and a compressor which comprises a quantizer and coder to provide a compressed output.

FIG. 9 illustrates a decoding system consisting of a decompressor which comprises an inverse coder and inverse quantizer, a synthesis filter bank, a subband predictor, and signal formatter to provide a recovered signal.

FIG. 10 illustrates a wired or wireless system consisting of an encoder, a means for transmitting the encoded or compressed data, a decoder to decompress the received signal from the encoder, and a conveyor as means to convey the recovered output signal.

FIG. 11 illustrates a three-channel, two-level analysis filter bank with prediction block at output of the higher frequency subbands where all decimation occurs prior to the prediction block.

FIG. 12 depicts the equivalent representation of filter bank in FIG. 11 where decimation occurs at output of prediction block.

FIG. 13 illustrates the well-known noble identities for multi-rate systems (from P. P. Vaidyanathan, Multirate Systems and Filter Banks, Prentice-Hall, 1993).

FIG. 14 illustrates a three-channel, two-level analysis filter bank, with distributed decimation around prediction block.

FIG. 15 illustrates a three-channel, two-level analysis filter bank predicting the higher frequency subbands where the second level and high-pass filters, H′₀(z) and H′₁(z), respectively, are different having a lesser number of taps than those used in the first level.

FIG. 16 illustrates the two-level analysis filter bank shown in FIG. 15 with distributed decimation around prediction block.

FIG. 17 illustrates analysis-by-synthesis predictions of the first level high-pass subband, Y₀(z) to obtain the predicted subband (Ŷ₀(z)) where H₀(z) and H₁(z) are part of the analysis filter bank and G₀(z) and G₁(z) correspond to the synthesis inverse discrete wavelet transform, IDWT.

FIG. 18 illustrates analysis-by-synthesis prediction of the first-level, high-pass subband, Y₀(z) to obtain the predicted subband Ŷ₀(z) which is the system in FIG. 17 using only partial interpolation.

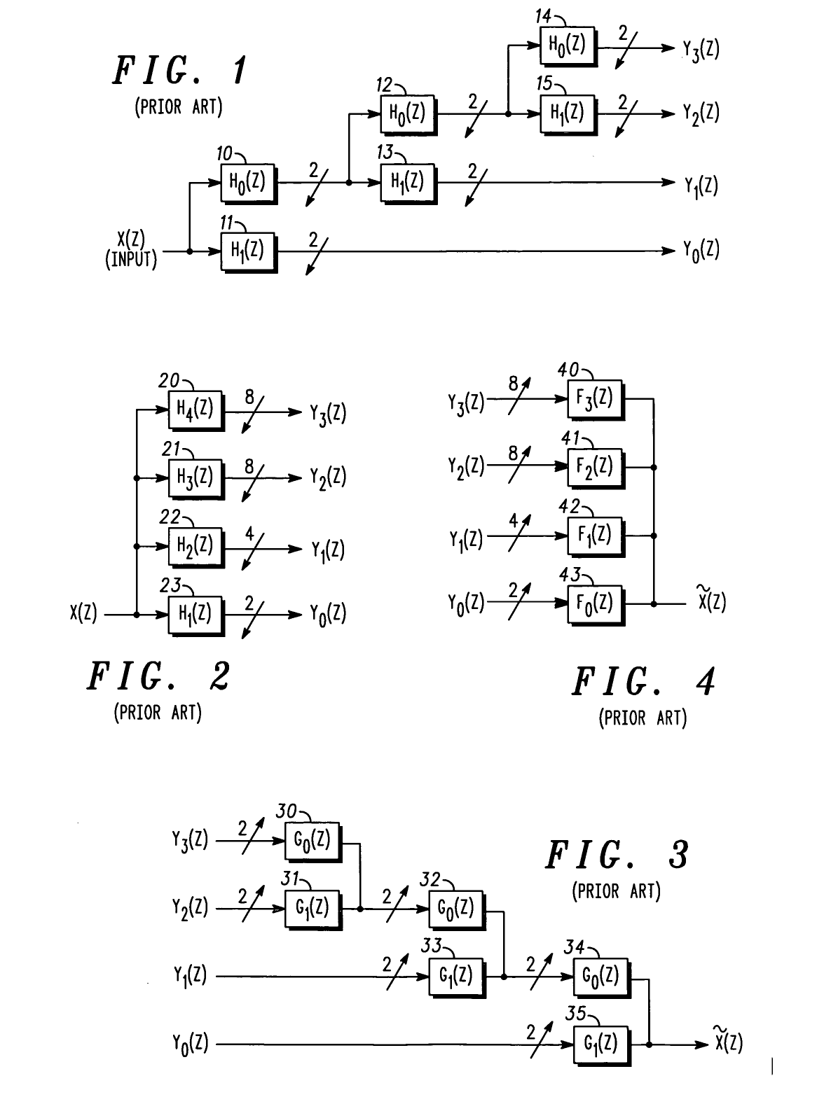

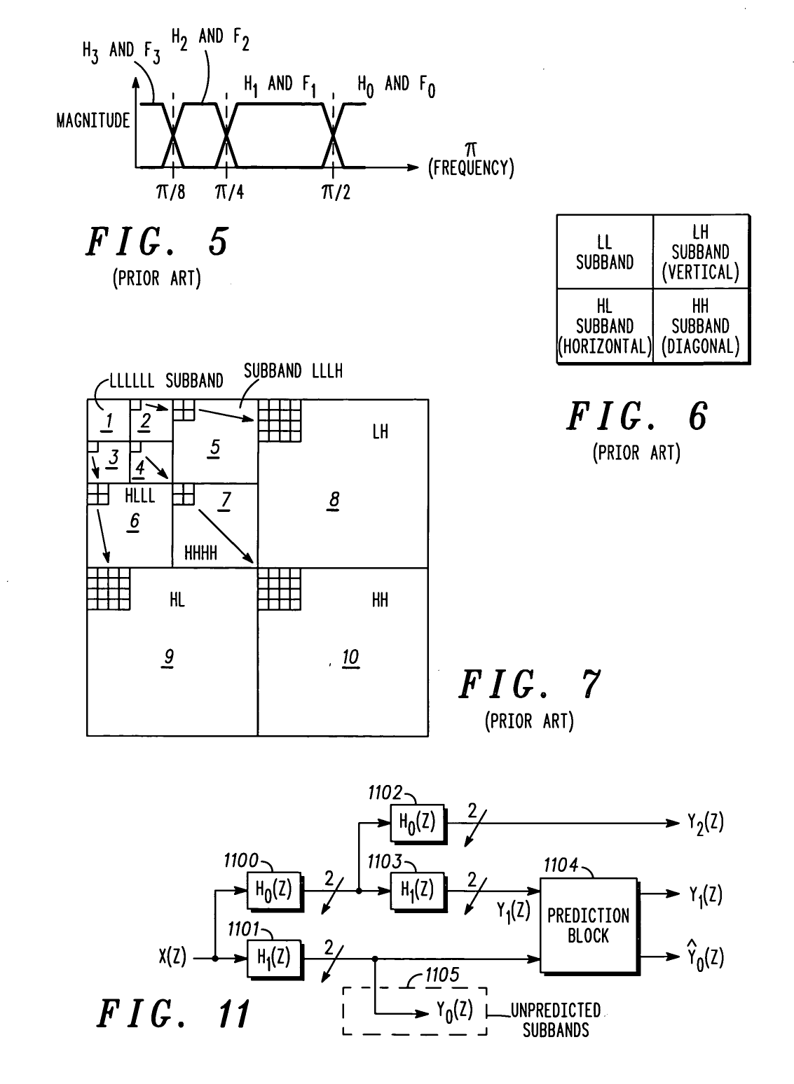

### DETAILED DESCRIPTION OF THE PREFERRED EMBODIMENT

The features of the present invention, which are believed to be novel, are set forth with particularly in the appended claims. The invention, together with further objects and advantages thereof, may best be understood with reference to the following description, taken in conjunction with the accompanying drawings, in the several figures of which like reference numerals identify like elements, and in which:

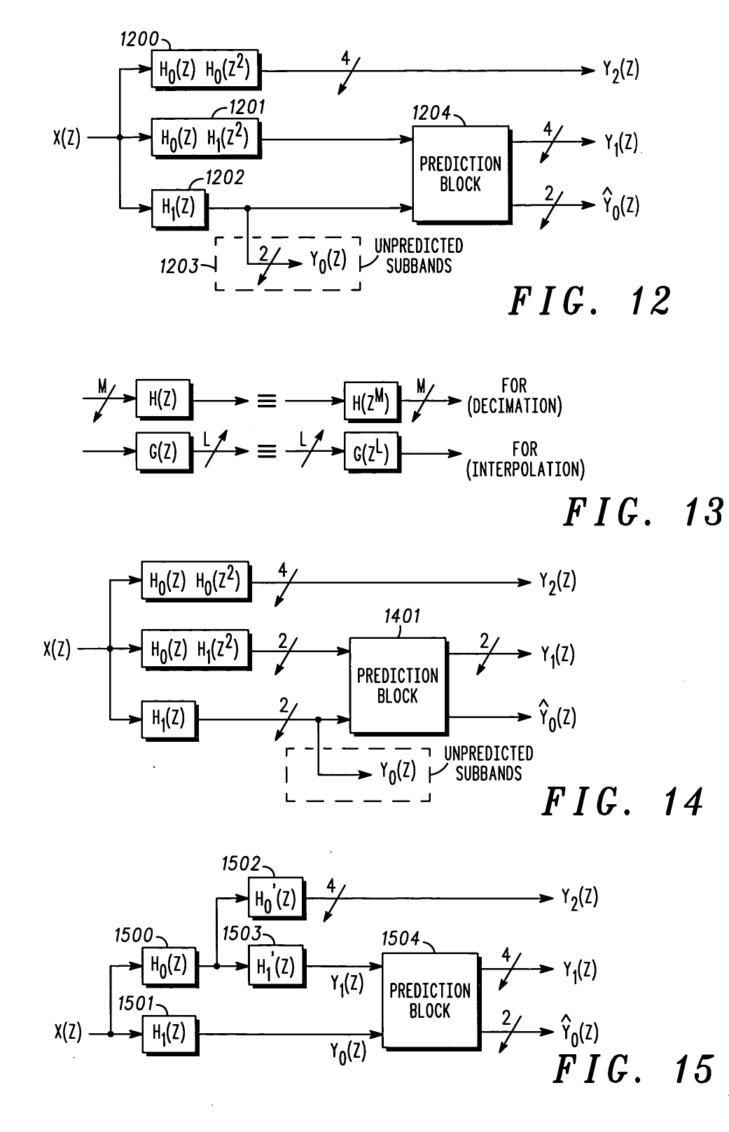

FIG. 8 illustrates an encoding system 800 consisting of input signal X(z) to an analysis filter bank 801 which can either take a form of any as that shown in FIGS. 11, 12, 14, 15, 16, 17, 18, and a compressor 802. The compressor 802 comprises a quantizer 803 to compress or quantize the subbands generated by the analysis filter bank, and coder 804 to further compress and format the data appropriately to provide a bit rate efficient compressed data output C(z).

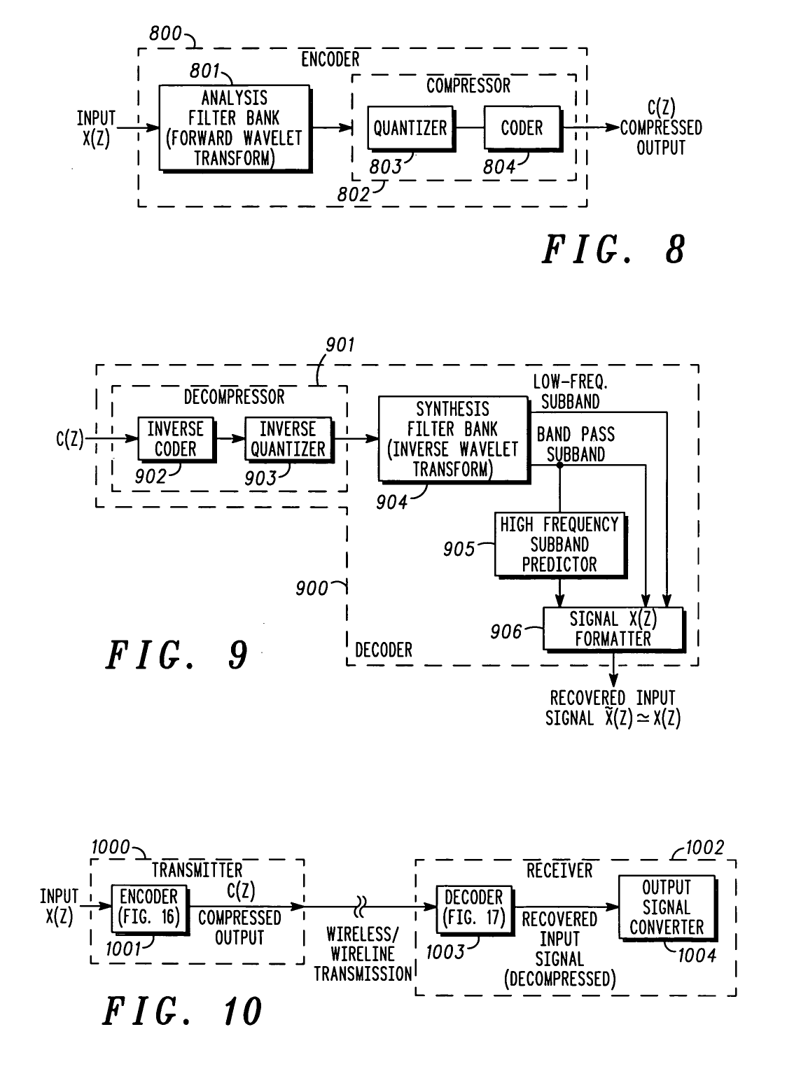

FIG. 9 illustrates a decoding system 900 consisting of an input compressed data signal C(z) to a decompressor 901. The decompressor 901 comprises an inverse coder 902 to decompress and un-format the data with the purpose of packing the data bytes in a form that facilitates subband correlation extraction during synthesis (inverse wavelet transformation, IDWT). An inverse quantizer 903 is used to further decompress the data. A synthesis filter bank 904 may take the form as that shown in FIGS. 17, 18, while a subband predictor 905 is used to extract those subbands that were not encoded or transmitted and which at the decoder are predicted from other spatially correlated subbands. The subband predictor 905 is used to improve the signal quality of the recovered signal. A signal formatter 906 is further used to arrange the data bytes of the recovered signal \tilde{X}(z). In the case where the arranged data is 2-dimensional, it may be ready to be displayed. It is highly desirable that the design of the encoding and decoding systems shown in FIGS. 8 and 9, respectively be such that the recovered signal \tilde{X}(z) shown at the output of FIG. 9 be as similar in quality as signal X(z) shown as input to FIG. 8.

FIG. 10 illustrates a wired or wireless system consisting of a transmitter 1000 comprising an encoder 1001 optionally having the form of the encoder shown in FIG. 8. The transmitter 1000 wirelessly transmits the signal from encoder 1001 in compressed output. A receiver 1002 comprising a decoder 1003 has a form as shown in FIG. 9 to decompress the received signal from the encoder. A converter 1004 such as a display is then used to allow viewing of the recovered and uncompressed signal.

It has been observed that the image subbands obtained from discrete wavelet transformation (DWT) processing of a two-dimension signal, such as an image, exhibit large magnitudes in contour lines which follow similar paths on the spatially correlated subbands. These contours contain the image edges, object outlines. The system proposed by this invention exploits the correlation that exists between certain subbands to reduce the number of bits necessary to code the discrete wavelet transformed image. The process of applying a wavelet transform signal decomposition stage in a subband coding system, such as the three-level analysis filter bank shown in FIG. 1, involves decimation of the samples (represented herein as “↓”) at the low-pass and high-pass filter outputs. Decimation introduces spatial location variance, which causes the spatial subband correlation among the subbands to be less obvious. This means decimation makes it more difficult to exploit the subband correlation. This invention proposes various systems to overcome the difficulty imposed by the decimation steps.

FIG. 11 shows decimation at the output of each filter 1100 as it is customarily seen in filter banks. Prediction block 1104 uses signal Y₁(z) to predict the higher frequency subbands 8, 9 and 10 corresponding to the subbands generated by a first-level discrete 2-D wavelet transformation (DWT). This predicted signal is denoted by Ŷ₀(z). As well known in the art, decimation reduces the amount of data. Therefore, decimation by 2, denoted by ↓2, causes the number of samples at the output of each filter (H₀(z) and H₁(z)) for the first level to be reduced by two. Therefore, for the case where X(z) is a 2-D input signal, the number of samples output of the first level DWT after horizontal and vertical processing is reduced by two along each dimension. In most analysis bank applications, the decimator is preceded by the filter to ensure that the signal being decimated is band-limited. The process of decimation, which is a linear but time-varying system, introduces spatial location variance, making cross-subband correlation much more difficult to exploit. A solution that lowers the number of computations from one level of the discrete-wavelet transformation (DWT) to the next DWT level is sought while minimizing the spatial location variance introduced by the decimation process.

As seen in FIG. 11, a one-dimensional or a two-dimensional signal processed separately is inputted to a two-level analysis filter bank 1100, 1101 in a subband coding system. All signals and filters are to be in the z-domain, the networks being considered in this embodiment are two level. However, it should be evident to those skilled in the art that such networks in the analysis of synthesis filter banks can easily be expanded to higher level systems. Signal X(n) is inputted to a quadrature mirror filter bank consisting of filter H₀(z) 1100 and high-pass filter H₁(z) 1101. The design of these FIR filters as well as the low-pass and high-pass synthesis filters H₀(z) and H₁(z), respectively, may be such as to guarantee perfect reconstruction of the entire encoding (analysis bank) and decoding (synthesis bank) system. Their number of terms and coefficient values are determined in the design process, whose procedure and imposed design criteria and requirements fall outside the scope of this invention.

It should also be noted that at the output of each filter, the signal is decimated by a factor of 2. Prediction block 1104 is added at the output of the higher frequency subbands after applying the first level wavelet filter bank 1101 and the bandpass subbands outputted by the second level wavelet filter bank 1100, 1101. All unpredicted subbands pass through unpredicted subband filter 1105. The low frequency subbands from this first level decomposition are again passed through the low-pass and high-pass analysis filters 1102, 1103 to obtain the output band-pass subbands Y₁(z) and the lowest frequency subband Y₂(z). Thus, the two-level analysis bank is applied as a separable transform to an input image signal X(z) yields a signal Y₁(z) which corresponds to band-pass subbands 5, 6, and 7 as shown in FIG. 7. Similarly, signal Y₀(z) corresponds to subbands 8, 9 and 10 also as shown in FIG. 7. Subbands 1, 2, 3, and 4, represented by Y₂(z) at the output of filter (1102) in FIG. 11, correspond spatially to the low-frequency subband region obtained after applying the two-level analysis bank of FIG. 11 horizontally and vertically as a separable transform to input signal X(z). Prediction block 1104 is used to predict subbands Y₀(z) from subbands Y₁(z) to yield Y₀(z). X(z) is a two-dimensional (2-D) input signal.

FIG. 12 shows an equivalent representation of the two-level analysis filter bank presented in FIG. 11, where the filters yielding the lowest frequency and bandpass subbands, Y₂(z) and Y₁(z), respectively, are expressed using the noble identities (from P. P. Vaidyanathan, Multirate Systems and Filter Banks, Prentice-Hall, 1993) illustrated in FIG. 13. If the functions representing filters H₀(z) and H₁(z) are rational, that is, polynominals in Z or Z⁻¹, then by using these noble-identities, one can easily arrive at the representation shown in FIG. 12. Prediction block 1204 is immediately placed after the filters H₁(z) (1202) and H₀(z)H₁(z²) 1201 and prior decimation with the purpose to eliminate any spatial location variance and allow optimal subband prediction. Unpredicted subbands are filtered using unpredicted subband filter 1203. However, the improved extraction of cross-band dependence is achieved at the expense of increased computational cost due to filtering. The lowest frequency subband from the two-level wavelet decomposition in FIG. 12 is Y₂(z) in the output path of filter 1200.

FIG. 14 illustrates a three-channel, two-level analysis filter bank, with distributed decimation around prediction block. This implementation differs from FIG. 12 in that a reduction in data size and computations can be achieved by performing partial decimation prior to the prediction block 1401. This scheme yields more computational cost at the predictor but less at the filtering step. This system provides a compromise between computational intensity and subband prediction effectiveness.

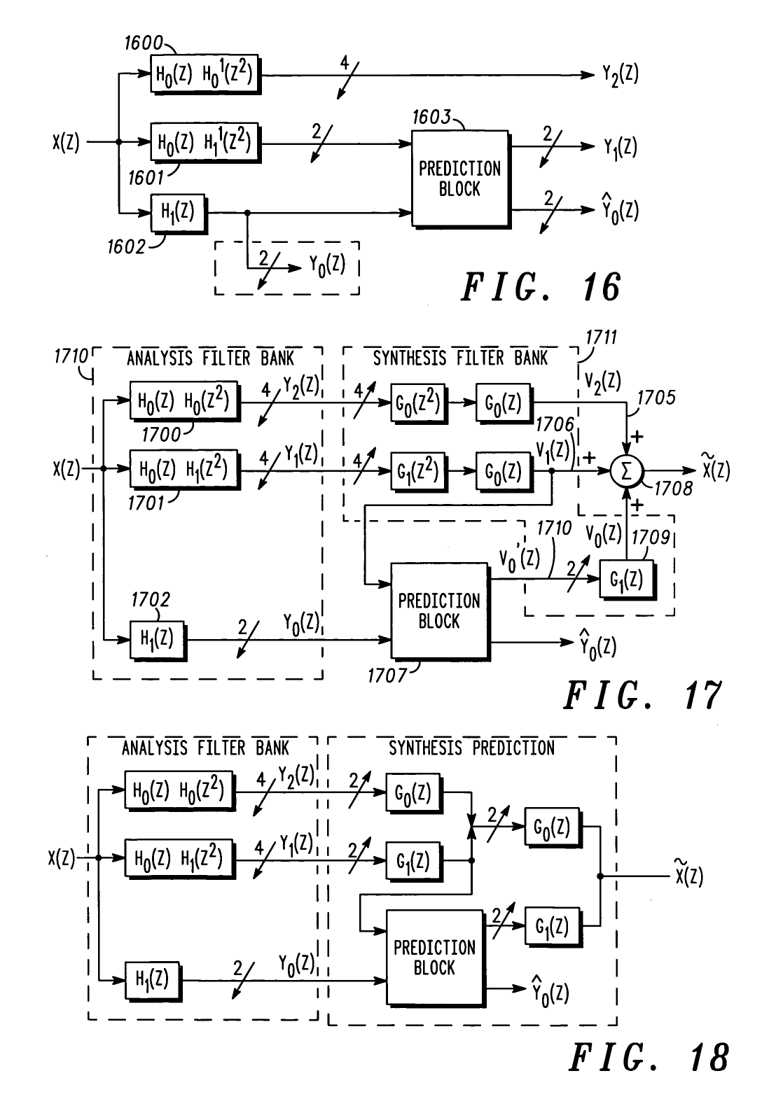

FIG. 15 illustrates a method to further reduce the amount of computations at the filtering step. The method illustrates a three-channel, two-level analysis filter bank with prediction of the higher frequency subbands Y₀(z) from the band-pass subbands Y₁(z) outputted after applying the second level wavelet transformation. Second level, and high-pass filters, H′₀(z) 1502 and H′₁(z) 1503, respectively, are different from those used in the first level wavelet transformation. These analysis filters have less number of taps than those used in the first level 1500 and 1501. This solution optimizes subband prediction while lowering the number of computations required at filtering by reducing the number of FIR filter taps or terms. By using shorter finite impulse response (FIR) filters for low-pass H′₀(z) 1502 and high-pass H′₁(z) 1503 filters in the second level of the discrete wavelet transformation, the computational cost is reduced without requiring partial decimation prior prediction. Again, by having the decimators in the band-pass subbands Y₁(z) and in the high-frequency subbands Y₀(z) at the output of prediction block 1504, spatial localization variance is minimized, allowing best prediction to be achieved for the high-frequency subbands. In systems where the wavelet transformation is followed by quantization and coding, such that perfect reconstruction is not a sought condition, using shorter FIR filters, H′₀(z) 1502 and H′₁(z) 1503 for the high-pass at the second and higher levels in a two-dimensional filter bank is a highly considerable approach for reducing the number of computations.

FIG. 16 shows a one-dimensional analysis filter bank, which can be used in a two-dimensional system as a separable transform by first applying the filter bank in one dimension (for example along y) then in the other dimension (for example along x). In this system the second level low-frequency subbands Y₂(z) are at the output of H₀(z)H₀¹(z²) 1600. Similarly, the band-pass subbands Y₁(z) are obtained from H₀(z)H′₁(z²) 1601 output path. FIG. 16 shows a system where the computational intensity at the filtering stages is reduced by using shorter FIR filters in the second stage, H′₀(z) and H′₁(z) 1602, and further by splitting the decimators in the band-pass subbands around the predictor block 1604. While this scheme offers less computations at filtering compared to that required in FIG. 15, it introduces certain spatial localization variance prior prediction due to decimation being split.

FIG. 17 illustrates analysis-by-synthesis prediction of the first level high-pass subbands Y₀(z) to obtain the predictor parameters Ŷ₀(z). H₀(z) and H₁(z), as denoted previously are part of the analysis filter bank, are represented in this two-level wavelet decomposition (1710) by filters H₀(z) H₀(z²) 1700, H₀(z) H₁(z²) 1701 and H₁(z) to yield in their output paths the lowest frequency subband Y₂(z), band-pass subbands Y¹(z) and highest frequency subbands Y₀(z), respectively. Similarly, G₁(z) and G₀(z) correspond to the synthesis inverse discrete wavelet transform, IDWT, represented by block 1711. Full interpolation (↑) illustrates that there is no distribution of the decimators around the predictor 1707. Only the output of V₁(z) 1706, in the inverse discrete wavelet transformation, IDWT, section of system 1711 is used by the predictor to extract the highest frequency subbands Y₀(z), from the synthesized signal V₁(z) 1706. In FIG. 17, this predicted subband is represented by signal V′₀(z). Thus, the output recovered signal \tilde{X}(z) is obtained by processing the lowest frequency subbands V₂(z) 1705, the bandpass subbands V₁(z) and the predicted subbands V′₀ (z), which must be filtered by the synthesis lowpass filter G₁(z) 1709 to yield V₀(z). It is then the summation 1708 of signals V₂(z), V¹(z), and V₀(z) which give the recovered input signal X(z) represented by \tilde{X}(z). It should be noted that \tilde{X}(z)=X(z) in a perfectly reconstructed system. However, in FIG. 17, \tilde{X}(z) illustrates a best approximation of the input signal X(z).

To completely avoid the spatial location variance due to decimation, FIG. 17 illustrates where the highest frequency subband, Y₀(z) is predicted to obtain the predictor parameters Ŷ₀(z) from the synthesized signal V₁(z) 1706. Again, V₁(z) is obtained by applying the inverse discrete wavelet transformation by using synthesis filters G₀(z) and G₁(z) to the second level band-pass filter output signal, Y₁(z). In the case of a two-dimensional input, such as an image, the channels, Y₀(z), Y₁(z) and Y₂(z) correspond to subbands [8, 9, 10] for signal Y₀(z), subbands [5, 6, 7] for Y₁(z) and [1, 2, 3, 4] for signal Y₂(z) where subbands [1, 2, 3, 4, 5, 6, 7, 8, 9, 10] are as shown in FIG. 7.

Again referring to FIG. 17, output signal \tilde{X}(z) is the sum of the synthesized subbands V₂(z) 1705 V₁(z) 1706 and V₀(z) 1710. The synthesis bank processes the outputs from the analysis bank at the encoder by performing the inverse discrete wavelet transformation. This process begins be interpolating by 4 the lowest frequency subband Y₂(z) and also interpolating by 4 the band-pass subband Y₁(z). The interpolated Y₂(z) signal is filtered by the filters G₀(z²)G₀(z) to obtain the synthesized signal V₂ (z) corresponding to the lowest frequency subbands of the recovered signal. Similarly, the interpolated Y₁(z) signal is filtered by G₁(z²)G₀(z) to obtain the synthesized signal V₁(z). V₁(z) from the synthesis bank and Y₀(z) from the analysis bank are inputted to the predictor to obtain the predictor parameters, denoted by Ŷ₀(z) and V′₀(z). Signal V′₀(z) is then filtered by the synthesis high-pass filter G₁(z) to obtain V₀(z).

The following equations, written in matrix form, show the relationship between the signals of FIG. 17. Inputs, outputs, and filters are all in the Z-domain. However, to simplify the expressions Z is omitted, for example,
Y⁽¹⁾(z)≡Y⁽¹⁾, H₀(z)≡H₀, H₀(z)X(z)H₀^{t}(z)≡H₀XH₀^{t} . . . and so on eq. (5)

Consider the two-dimensional case as an extension of the one-dimensional case. Let X(z)≡X be the input image of size N×N. At the analysis bank, the forward discrete wavelet transforms (DWT) in FIG. 17 is represented as a two-dimensional two-level filter bank. Applying this analysis bank along both dimensions of input image X(z), the first-level DWT, Y⁽¹⁾ is expressed as:

$$\begin{matrix}{Y}^{( 1 )} = [ \begin{matrix}{H}_{0} \\ {H}_{1}\end{matrix} ] X [ \begin{matrix}{H}_{0}^{t} & {H}_{1}^{t}\end{matrix} ] \\ = [ \begin{matrix}{H}_{0} {XH}_{0}^{t} & {H}_{0} {XH}_{1}^{t} \\ {H}_{1} {XH}_{0}^{t} & {H}_{1} {XH}_{1}^{t}\end{matrix} ] \\ = [ \begin{matrix}{Y}_{LL} & {Y}_{LH} \\ {Y}_{HL} & {Y}_{HH}\end{matrix} ]\end{matrix} \qquad eq . ( 6 )$$

where H₀^{t} represents the transpose of the matrix representation of analysis H₀(z)≡H₀. Similarly H₁^{t} represents transpose of the matrix representation of analysis high-pass H₁(z)≡H₁.

Y_{LL}, Y_{LH}, Y_{HL}, and Y_{HH} are the four subbands obtained after applying the first level forward discrete wavelet transform, DWT. Y_{LL} represents the low-frequency subband, Y_{LH} and Y_{HL} are band-pass vertically oriented subband and band-pass horizontally oriented subband, respectively. Y_{HH} is the high frequency (diagonal) subband. Referring to FIG. 17, Y₀(z) corresponds to Y_{HL}, Y_{LH} and Y_{HH} when processing the analysis band two-dimensionally. Again considering the case where the input signal is two-dimensional, the second level forward discrete wavelet transformation, DWT, uses the decimated subband Y_{LL} from the first level as the input to the second level, in order to obtain signal Y⁽²⁾ in eq. (7). In eq. (7) signal Y⁽²⁾ contains subbands Y_{HL}, Y_{LH}, and Y_{HH}, which are the first level decomposition subbands related to signal Y₀(z) shown in FIG. 17. Matrix Y⁽²⁾ will also contain the elements obtained by applying the second level DWT to Y_{LL} of eq. (6) to give the two-dimensional representation of signals Y₁(z) and Y₂(z). It can also be easily observed that Y₂(z) in FIG. 17 corresponds to subband Y_{LLLL} in eqs. (7) and (8) and similarly Y₁(z) corresponds to subbands Y_{LLLH}, Y_{HLLL}, and Y_{HHHH} also from eq. (7), eq. (9), eq. (10) and eq. (11).

$$\begin{matrix}{Y}^{( 2 )} = [ \begin{matrix}[ \begin{matrix}{H}_{0}^{′} \\ {H}_{1}^{′}\end{matrix} ] {Y}_{LL} [ \begin{matrix}{H}_{0}^{′ t} & {H}_{1}^{′ t}\end{matrix} ] & {Y}_{LH} \\ {Y}_{HL} & {Y}_{HH}\end{matrix} ] \\ = [ \begin{matrix}[ \begin{matrix}{H}_{0}^{′} {Y}_{LL} {H}_{0}^{′ t} & {H}_{0}^{′} {Y}_{LL} {H}_{1}^{′ t} \\ {H}_{1}^{′} {Y}_{LL} {H}_{0}^{′ t} & {H}_{1}^{′} {Y}_{LL} {H}_{1}^{′ t}\end{matrix} ] & {Y}_{LH} \\ {Y}_{HL} & {Y}_{HH}\end{matrix} ] \\ = [ \begin{matrix}[ \begin{matrix}{Y}_{LLLL} & {Y}_{LLLH} \\ {Y}_{HLLL} & {Y}_{HHHH}\end{matrix} ] & {Y}_{LH} \\ {Y}_{HL} & {Y}_{HH}\end{matrix} ]\end{matrix} \qquad eq . ( 7 )$$

where the second-level discrete wavelet transformation (DWT) processing is expressed with “primed” matrices shown in eq. (7) and ‘t’ denotes transpose. From equation (7) we derive:
Y_{LLL}=H₀′Y_{LL}H₀′^{t} eq. (8)
Y_{LLLH}=H₀′Y_{LL}H₁′^{t} eq. (9)
Y_{HLLL}=H₁′Y_{LL}H₀′^{t} eq. (10)
Y_{HHHH}=H₁′Y_{LL}H₁′^{t} eq. (11)
Again, ‘t’ denoting the transpose of the matrix and ‘primed’ representing the second-level discrete wavelet transformation.
Applying now synthesis to subbands Y_{LLLL}, Y_{LLLH}, Y_{HLLL}, Y_{HHHH}, we have:

$${Y}_{LL} = [ \begin{matrix}{G}_{0}^{′ t} & {G}_{1}^{′ t}\end{matrix} ] [ \begin{matrix}{H}_{0}^{′} {Y}_{LL} {H}_{0}^{′ t} & {H}_{0}^{′} {Y}_{LL} {H}_{1}^{′ t} \\ & \\ {H}_{1}^{′} {Y}_{LL} {H}_{0}^{′ t} & {H}_{1}^{′} {Y}_{LL} {H}_{1}^{′ t}\end{matrix} ] [ \begin{matrix}{G}_{0}^{′} \\ {G}_{1}^{′}\end{matrix} ] \qquad eq . ( 12 )$$

where G₀′, and G₁′ are the and high-pass synthesis filters in matrix form. t denotes the transpose of the matrix, such that G₀′^{t} is the matrix transposed of G₀′ matrix filter and G₁′^{t} is the matrix transposed of the high-pass filter G₁′ also represented in matrix form.
With invertibility conditions
I=. G₀′^{t}H₀′+G₁′^{t}H₁′ eq. (13)
I=H₀′^{t}G₀′+H₁′^{t}G₁′ eq. (14)
where I is the Identity matrix.
Therefore from eq. (12) the synthesized LL subband is the sum of four parts, of which the ones of interest are:
S_{LH}=G₁′^{t}H₁′Y_{LL}H₀′^{t}G₀′ (vertical subband) eq. (15)
S_{HL}=G₁′^{t}H₁′Y_{LL}H₀′^{t}G₀′ (horizontal subband) eq. (16)
S_{HH}=G₁′^{t}H₁′Y_{LL}H₁′^{t}G₁′ (diagonal subband) eq. (17)
The vertical, horizontal, and diagonal subbands of eq. (15), (16), and (18), respectively, correspond to signal V₁(z) of FIG. 17 assuming two-dimensional processing. Therefore, these are the signals of interest to be applied to the predictor block of FIG. 17.

Several known methods or models of prediction such as auto-regressive-moving,-average (ARMA), moving average (MA), auto-regressive (AR), linear, may be used to predict the desired subbands. For example, the process of predicting the vertical subband, Y_{LH}, resulting from a first-level discrete wavelet transformation after applying a first-level analysis filter bank, from a synthesized S_{LH} subband expressed accordingly in equation (15), may be expressed by the general equation (18) as follows:
Predicted vertical subband≡Predicted Y_{LH}≡Ŷ_{LH}=P(Y_{LH}, S_{LH}) eq. (18)
Similarly,
Predicted horizontal subband≡Predicted Y_{HL}≡Ŷ_{HL}=P(Y_{HL}, S_{HL}) eq. (19)
and
Predicted diagonal subband≡Predicted Y_{HH}≡Ŷ_{HH}=P(Y_{HH}, S_{HL}) eq. (20)
Where Ŷ denotes predicted subband, S_{LH}, S_{HL}, and S_{HH} are the synthesized subband from the second-level inverse wavelet transformation as given by equations (15), (16), and (17), respectively.

FIG. 18 illustrates analysis-by-synthesis prediction of the first-level, high-pass subband, Y₀(z) to obtain the predicted subband Ŷ₀(z). H₀(z) and H₁(z) are the low and high-pass filters, respectively, corresponding to the analysis filter bank. G₀(z) and G₁(z) are the low-pass and high-pass synthesis filters, respectively, corresponding to the inverse discrete wavelet filter bank (IDWT). FIG. 18 shows the system in FIG. 17 with partial interpolation in front of synthesis.

Thus, in summary, the invention includes an encoder and decoder that utilizes a filter bank to decorrelate an input data signal; decimators to down sample the filtered input data signal and a predictor to extract cross-subband dependence. A decoder then recovers the received data signal and includes interpolators to upsample the received compressed data signal, multilevel filter bank to perform an inverse wavelet transformation and a predictor to extract cross-subband correlations.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. An encoder for encoding an input data signal comprising:
an analysis filter bank to decorrelate an input data signal;
a plurality of decimators to down sample the filtered input data signal; and
a predictor to extract cross-subband dependence.

2. The encoder of claim 1, wherein the analysis filter bank includes a multi-level filter bank.

3. The encoder of claim 2, wherein the input data signal is two-dimensional.

4. The encoder of claim 3, wherein a predictor extracts higher frequency subbands that result from a first-level two-dimensional decomposition performed by the analysis filter bank from subbands obtained from higher levels of a two-dimensional decomposition performed by the analysis bank.

5. The encoder of claim 4, wherein the two-dimensional decomposition is performed along one dimension first by processing the analysis filter bank as a separable transform.

6. The encoder of claim 4, wherein full decimation is performed prior to a predictor that extracts cross-subband dependence.

7. The encoder of claim 5, wherein full decimation is performed prior to a predictor that extracts cross-subband dependence.

8. The encoder of claim 4, wherein full decimation is performed after a predictor to minimize spatial location variance introduced by decimation.

9. The encoder of claim 4, wherein partial decimation is performed after both the analysis filter and the predictor for reducing the number of computations by the analysis filter and decimation.

10. The encoder of claim 5, wherein full decimation is performed after the predictor to minimize spatial location variance introduced by the decimation.

11. The encoder of claim 5, wherein partial decimation is performed after both the analysis filter and the predictor for reducing the number of computations by the analysis filter and the decimation.

12. An encoder for encoding an input data signal comprising:
a multi-level analysis filter bank for decimating an input data signal;
a plurality of decimators for down sampling the filtered input data signal;
a predictor for extracting cross-subband dependence; and
wherein the second and higher-ordered levels of the filter bank are finite impulse response (FIR) filters with fewer elements than those in the first-level FIR filter bank.

13. The encoder of claim 12, wherein a predictor extracts the higher-frequency subbands resulting from a first-level two-dimensional decomposition performed by the analysis filter bank from higher frequency subbands obtained from higher levels of a two-dimensional decomposition performed by the analysis bank.

14. The encoder of claim 13, wherein the two-dimensional decomposition is performed by processing the analysis bank as a separable transform.

15. The encoder of claim 13, wherein full decimation is performed prior to the predictor.

16. The encoder of claim 13, wherein full decimation is performed after the predictor for minimizing spatial location variance introduced by the decimation.

17. The encoder of claim 13, wherein partial decimation is performed after both the analysis filter and the predictor for reducing the number of computations by the analysis filter and decimation.

18. The encoder of claim 14, wherein full decimation is performed after the predictor for minimizing spatial location variance introduced by the decimation.

19. The encoder of claim 14, wherein partial decimation is performed after both the analysis filter and the predictor for reducing the number of computations by the analysis and the decimation.

20. An encoder for encoding an input data signal comprising:
a multi-level analysis filter bank for decorrelating an input data signal;
a plurality of decimators for down sampling the filtered input data signal; and
a compressor including a quantizer and coder for reducing the amount of down sampled data from the second and higher levels of wavelet decomposition.

21. An encoder of claim 20, wherein the output of the compressor is transmitted to a receiver for decoding the compressed data signal.

22. A decoder for recovering a compressed received data signal comprising:
a plurality of interpolators for upsampling a received compressed data signal;
a multi-level synthesis filter bank for performing an inverse wavelet transformation filter bank; and
a predictor for extracting cross-subband correlations.

23. A decoder for recovering a compressed data signal comprising:
a de-compressor including an inverse quantizer and inverse coder for expanding the reduced amount of received data;
a plurality of interpolators for sampling compressed data signal;
a multi-level synthesis filter bank for performing an inverse wavelet transformation filter bank; and
a predictor for extracting cross-subband correlations.

24. The decoder in claim 23 further comprising a means for conveying the recovered data signal.

25. A decoder for recovering a compressed data signal comprising:
a de-compressor including an inverse quantizer and inverse coder for expanding the reduced amount of received data;
a plurality of interpolators for upsampling a compressed data signal;
a multi-level synthesis filter bank for performing an inverse wavelet transformation filter bank; and
a predictor for extracting higher-frequency subbands corresponding to the first-level decomposition of an analysis wavelet filter bank.

26. The decoder in claim 25 further comprising a means for conveying the recovered data signal.

27. A decoder for recovering a compressed received data signal comprising:
a plurality of full interpolators for upsampling a compressed data signal prior synthesis filtering,
a multi-level synthesis filter bank for performing an inverse wavelet transformation filter bank; and
a predictor to extract cross-subband correlations.

28. A decoder for recovering a compressed received data signal comprising:
a plurality of partial interpolators for partially upsampling a compressed data signal prior synthesis filtering,
a multi-level synthesis filter bank for performing an inverse wavelet transformation filter bank;
a predictor for extracting cross-subband correlations, and
a plurality of partial interpolators for partially upsampling the extracted data from the predictor.

29. A decoder for recovering a compressed data signal comprising:
a de-compressor including an inverse quantizer and inverse coder for expanding the reduced amount of received data;
a plurality of full interpolators for upsampling compressed data signal prior synthesis filtering,
a multi-level synthesis filter bank for performing an inverse wavelet transformation filter bank; and
a predictor for extracting cross-subband correlations.

30. The decoder in claim 29, wherein the predictor extracts higher frequency subbands corresponding to the first-level decomposition of an analysis wavelet filter bank.

31. A decoder for recovering a compressed data signal comprising:
a de-compressor including an inverse quantizer and inverse coder for expanding the reduced amount of received data;
a plurality of partial interpolators for partially upsampling a compressed data signal prior synthesis filtering;
a multi-level synthesis filter bank for performing an inverse wavelet transformation filter bank;
a predictor for extracting cross-subband correlations, and
a plurality of partial interpolators for partially upsampling the extracted data from the predictor.

32. The decoder in claim 31, wherein the predictor extracts higher frequency subbands corresponding to the first-level decomposition of an analysis wavelet filter bank.

33. An encoding-decoding system for processing data signals comprising:
an encoder including:
a multi-level analysis filter band for decorrelating an input data signal;
a plurality of decimators for down sampling a filtered input data signal;
a quantizer for processing only the subbands from the second and higher levels of wavelet decomposition;
a coder for compressing the subbands from the second and higher levels of wavelet decomposition;
a decoder including:
an inverse quantizer for decompressing received subbands;
an inverse coder for decompressing received subbands;
a plurality of interpolators for upsampling the received compressed data signal;
a multi-level synthesis filter bank for performing an inverse wavelet transformation filter bank; and
a predictor for extracting the subbands from the first level decomposition that were not transmitted based on data of their spatially correlated subbands from other levels of decomposition.
